(19) United States
(12) Patent Application Publication
(10) Pub. No.: US 2004/0128695 A1
(43) Pub. Date: Jul. 1, 2004

(54) Television broadcast content distributing system using virtual local area networks

(75) Inventor: Akihiro Shin, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/736,647

(22) Filed: Dec. 17, 2003

(30) Foreign Application Priority Data
Dec. 18, 2002 (JP) 2002-366045

(51) Int. Cl. H04N 7/173; H04N 7/16

(52) U.S. Cl. 725/95; 725/117; 725/147; 725/118

(57) ABSTRACT

In a television broadcast content distributing system, a plurality of television broadcast content distributing servers generate television broadcast contents, and a plurality of television broadcast content receiving terminals receive the television broadcast contents. Also, a first channel allocating switch is connected to the television broadcast content distributing servers to allocate channels to the television broadcast content distributing servers, respectively. On the other hand, a plurality of second channel allocating switches are provided. Each of the second allocating switches is connected to one or more of the television broadcast content receiving terminals, to thereby allocate one or more of the channels to the one or more of the television broadcast content receiving terminals. Further, a plurality of virtual local area networks are provided. Each of the VLANs is arranged in correspondence with one of the channels between outputs of the first channel allocating switch and inputs of the second channel allocating switches.

### BACKGROUND OF THE INVENTION

1. Field of the Invention

The present invention relates to a television broadcast content distributing system for distributing television broadcast contents of a plurality of channels to a plurality of television broadcast content receiving terminals.

2. Description of the Related Art

In the Internet, as data to be transmitted has become diversified and the speed of communication paths has been increased, various kinds of content distributing systems have been developed. One of such content distributing systems is a television broadcast content distributing system which is called Internet television.

In a first television broadcast content distributing system (see: JP-A-2002-185900 & JP-A-2002-204438), when a television broadcast content receiving terminal requests a television broadcast content distributing server via the Internet to record a desired television broadcast content, the desired television broadcast content is stored in a memory of the television broadcast content distributing server. Then, upon receipt of a reproduction request via the Internet from the television broadcast content receiving terminal, the television broadcast content distributing server transmits the above-mentioned desired television content via the Internet to the television broadcast content receiving terminal, so that the desired television content can be reproduced therein. Thus, the user can view the desired television content.

In the above-described first prior art television broadcast content distributing system, however, since the television broadcast content distributing server just serves as a video tape recorder, the user cannot view television contents other than the desired television content which is determined in advance. Also, the user cannot view channels other than a predetermined channel.

In a second prior art television broadcast content distributing system, some homepages on the Internet may include television broadcast contents, so that a television broadcast content receiving terminal can access such homepages to obtain the television broadcast contents via the Internet.

In the above-described second prior art television broadcast content distributing system, however, since the television broadcast contents in the homepages are obtained by performing a data-compression method such as a Moving Picture Experts Group (MPEG) method upon predetermined television broadcast contents which are generally short contents such as several-minute contents, it is impossible to view relatively long television broadcast contents such as an on-the-spot broadcast content.

A third prior art television broadcast content distributing system uses a unicast technology for distributing television broadcast contents of different channels from one television broadcast content distributing server via the Internet to a plurality of television broadcast content receiving terminals. This will be explained later in detail.

In the above-described third prior art television broadcast content distributing system, however, when the number of television broadcast content receiving terminals is increased, the operation speed of the television broadcast content distributing server needs to be increased, which is an obstacle to construction of the television broadcast content distributing system.

A fourth prior art television broadcast content distributing system uses a multicast technology for distributing the same television broadcast content of one channel from one television broadcast content distributing server via the Internet to a plurality of television broadcast content receiving terminals. This also will be explained later in detail.

In the above-described fourth prior art television broadcast content distributing system, however, when each of the television broadcast content receiving terminals changes a selected channel, the television broadcast content distributing system needs to be reconstructed, which is cost and time consuming.

### SUMMARY OF THE INVENTION

It is an object of the present invention to provide a television broadcast content distributing system capable of switching a selected channel without consuming cost and time.

According to the present invention, in a television broadcast content distributing system, a plurality of television broadcast content distributing servers generate television broadcast contents, and a plurality of television broadcast content receiving terminals receive the television broadcast contents. Also, a first channel allocating switch is connected to the television broadcast content distributing servers to allocate channels to the television broadcast content distributing servers, respectively. On the other hand, a plurality of second channel allocating switches are provided. Each of the second allocating switches is connected to one or more of the television broadcast content receiving terminals, to thereby allocate one or more of the channels to the one or more of the television broadcast content receiving terminals. Further, a plurality of virtual local area networks (VLANs) are provided. Each of the VLANs is arranged in correspondence with one of the channels between outputs of the first channel allocating switch and inputs of the second channel allocating switches.

### BRIEF DESCRIPTION OF THE DRAWINGS

The present invention will be more clearly understood from the description set forth below, as compared with the prior art, with reference to the accompanying drawings, wherein:

FIG. 1 is a circuit diagram illustrating a prior art television broadcast content distributing system using a unicast technology;

FIG. 2 is a block circuit diagram illustrating another prior art television broadcast content distributing system using a multicast technology;

FIG. 3 is a block circuit diagram illustrating a first embodiment of the television broadcast content distributing system according to the present invention;

FIG. 4 is a detailed block circuit diagram of the distributing network of FIG. 3;

FIGS. 5A and 5B are block circuit diagrams illustrating examples of the television broadcast content receiving terminals of FIG. 4;

FIG. 6 is a detailed block circuit diagram of the channel allocating switch on the side of the television broadcast content receiving terminals of FIG. 4;

FIG. 7 is a diagram illustrating an example of the media access control (MAC) address-to-VLAN storing section of FIG. 6;

FIGS. 8 and 9 are flowcharts for explaining the operation of the control section of FIG. 6;

FIG. 10 is a diagram for explaining a menu image displayed in the flowcharts of FIGS. 8 and 9;

FIG. 11 is a flowchart of a modification of the flowchart of FIG. 8;

FIG. 12 is a block circuit diagram illustrating a second embodiment of the television broadcast content distributing system according to the present invention;

FIG. 13 is a detailed block circuit diagram of the channel allocating switch on the side of the television broadcast content receiving terminals of FIG. 12;

FIGS. 14 and 15 are flowcharts for explaining the operation of the control section of FIG. 13;

FIG. 16 is a flowchart for explaining the operation of the default server of FIG. 12; and

FIG. 17 is a block diagram illustrating an actual television broadcast content distributing system using the systems of FIGS. 3 and 12.

### DESCRIPTION OF THE PREFERRED EMBODIMENTS

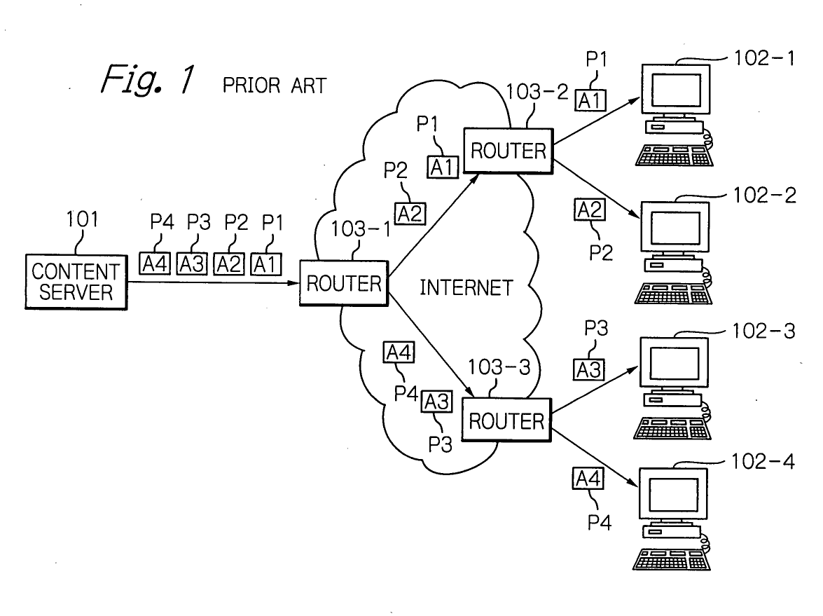

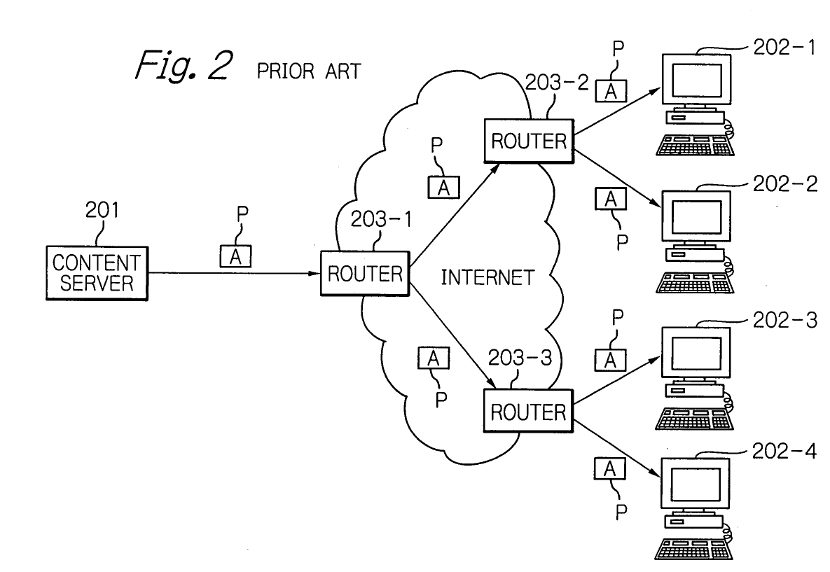

Before the description of the preferred embodiments, prior art television broadcast content distributing systems will be explained with reference to FIGS. 1 and 2.

In FIG. 1, which illustrates a prior art television broadcast content distributing system using a unicast technology which has already been discussed as the third prior art television broadcast content distributing system, a television broadcast content distributing server 101 is connected via the Internet to television broadcast content receiving terminals (personal computers) 102-1, 102-2, 102-3 and 102-4 to which different Internet protocol (IP) addresses A1, A2, A3 and A4 are allocated in advance. In this case, routers 103-1, 103-2 and 103-3 are arranged in a hierarchical tree configuration within the Internet.

The television broadcast content distributing server 101 transmits packets P1, P2, P3 and P4 having destination IP addresses A1, A2, A3 and A4, respectively, to the router 103-1. As a result, the packet P1 is branched at the router 103-1 to the router 103-2, and then, the packet P2 is branched at the router 103-2 to the television broadcast content receiving terminal 102-1. Also, the packet P2 is branched at the router 103-1 to the router 103-2, and then, the packet P2 is branched at the router 103-2 to the television broadcast content receiving terminal 102-2. Similarly, the packet P3 is branched at the router 103-1 to the router 103-3, and then, the packet P2 is branched at the router 103-3 to the television broadcast content receiving terminal 102-3. Also, the packet P4 is branched at the router 103-1 to the router 103-2, and then, the packet P2 is branched at the router 103-3 to the television broadcast content receiving terminal 102-4. Thus, the television broadcast content receiving terminals 102-1, 102-2, 102-3 and 102-4 can view different television broadcast contents.

In FIG. 1, however, a broadcast between the television broadcast content distributing server 101 and one of the television broadcast content receiving terminals 102-1, 102-2, 102-3 and 102-4 is carried out on a point-to-point basis. Therefore, if each of the television broadcast content receiving terminals 102-1, 102-2, 102-3 and 102-4 requires “m” packets per unit time, the television broadcast content distributing server 101 needs to generate “m x n” packets per unit time where “n” is a number of the television broadcast content receiving terminals such as “4”. Therefore, when the number of television broadcast content receiving terminals is increased, the operation speed of the operation speed of the television broadcast content distributing server 101 needs to be increased, which is an obstacle to construction of the television broadcast content distributing system.

In FIG. 2, which illustrates another prior art television broadcast content distributing system using a multicast technology which has already been discussed as the fourth prior art television broadcast content distributing system, a television broadcast content distributing server 201 is connected via the Internet to television broadcast content receiving terminals (personal computers) 202-1, 202-2, 202-3 and 202-4 to which the same IP address A is allocated in advance. In this case, routers 203-1, 203-2 and 203-3 are arranged in a hierarchical tree configuration within the Internet.

The television broadcast content distributing server 201 transmits a packet P having a destination IP address A to the router 203-1. As a result, the packet P is doubled at the router 203-1, and then, each packet is transmitted to the routers 203-2 and 203-3, respectively. Also, the packet is doubled at each of the routers 203-2 and 203-3, and then, each packet P reaches the television broadcast content receiving terminals 202-1, 202, 203 and 204, respectively. Thus, the television broadcast content receiving terminals 202-1, 202-2, 202-3 and 202-4 can view the same television broadcast content.

In FIG. 2, a broadcast between the television broadcast content distributing server 201 and the television broadcast content receiving terminals 202-1, 202-2, 202-3 and 202-4 is carried out on a point-to-multipoint basis. Therefore, even when the number of television broadcast content receiving terminals is increased, the operation speed of the television broadcast content distributing server 101 does not need to be increased, although the hierarchical tree configuration of routers becomes more complex.

In FIG. 2, however, when one of the television broadcast content receiving terminals changes a selected channel to view television broadcast contents of another channel, this television broadcast content receiving terminal has to belong to another television broadcast content distributing server, i.e., another multicast group having a different IP address. That is, the hierarchical tree configuration of routers has to be reconstructed. If this telephone broadcast content receiving terminal is located near a router of the other multicast group, the hierarchical tree configuration of routers can be easily reconstructed. However, if this telephone broadcast content receiving terminal is located far from a router of the other multicast group, the hierarchical tree configuration of routers can be difficult to reconstruct, which is also an obstacle to construction of the television broadcast content distributing system.

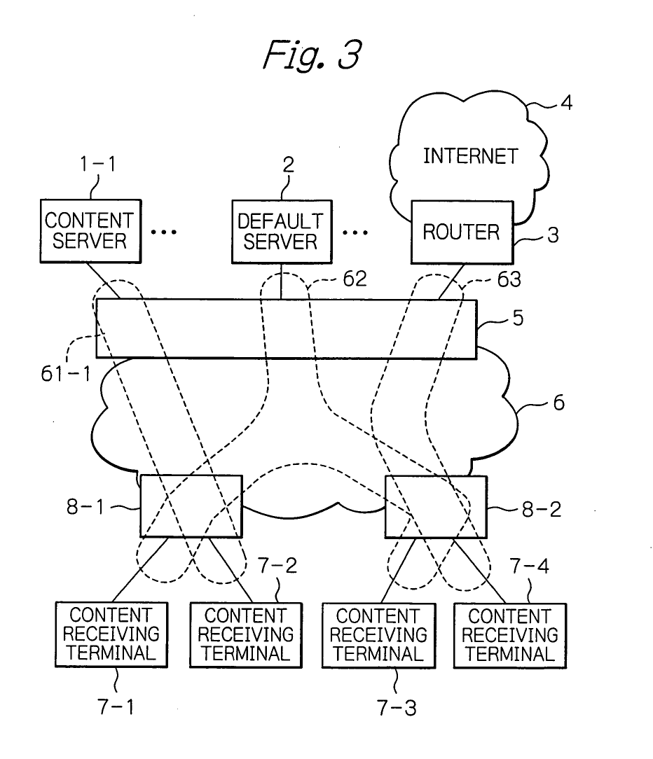

In FIG. 3, which illustrates a first embodiment of the television broadcast content distributing system according to the present invention, television broadcast content distributing servers 1-1, 1-2, . . . , 1-N (also see FIG. 2) for generating television broadcast contents, a default server 2 for generating a menu of the television broadcast contents generated from the television broadcast content distributing servers 1-1, 1-2, . . . , 1-N, and a router 3 connected to the Internet 4 are connected to a channel allocating switch 5 within a distributing network 6.

On the other hand, television broadcast content receiving terminals (personal computers) 7-1 and 7-2 are connected to a channel allocating switch 8-1 within the distributing network 6, and also, television broadcast content receiving terminals (personal computers) 7-3 and 7-4 are connected to a channel allocating switch 8-2 within the distributing network 6. In this case, the television broadcast content receiving terminals 7-1 and 7-2 are closer to the channel allocating switch 8-1 than the channel allocating switch 8-2, while the television broadcast content receiving terminals 7-3 and 7-4 are closer to the channel allocating switch 8-2 than the channel allocating switch 8-1.

The distributing network 6 forms vertical local area networks (VLANs) 61-1, 61-2, . . . , 61-N (see also FIG. 2), 62 and 63 between the channel allocating switch 5 and the channel allocating switch 7. In more detail, the VLANs 61-1, 61-2, . . . , 61-N are broadcast VLANs for the television broadcast content distributing servers 1-1, 1-2, . . . , 1-N; the VLAN 62 is a default VLAN for the default server 2; and the VLAN 63 is an Internet VLAN for the router 3.

VLAN technology is defined by the Institute of Electrical and Electronics Engineers, Inc (IEEE) 802. 1Q. Virtual groups can be realized on LANs simply by combining nodes (points) independent of physical communication cables and connection of terminals thereto.

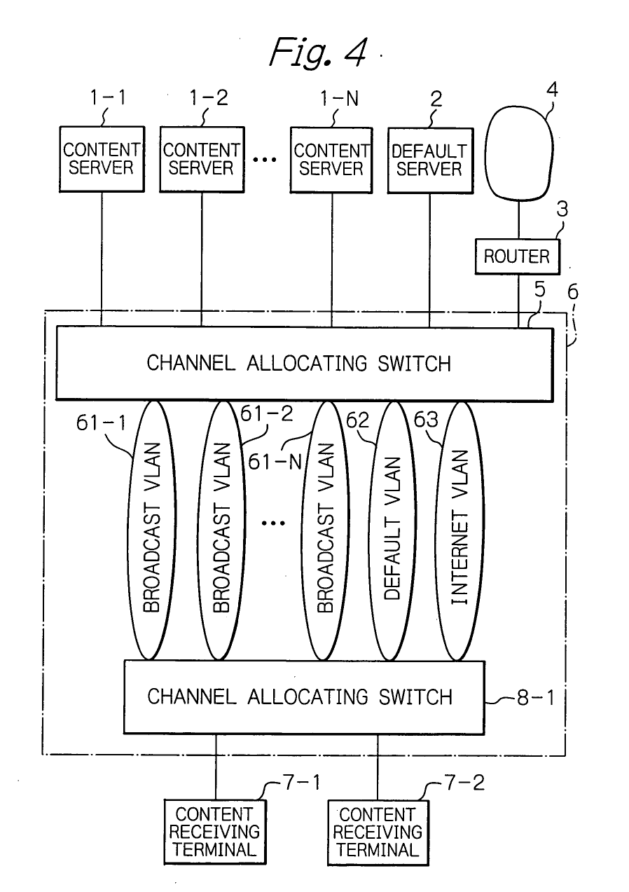

In FIG. 4, which is a detailed block circuit diagram of the distributing network 6 of FIG. 3, the channel allocating switch 8-1 of FIG. 3 is illustrated, but the channel allocating switch 8-2 of FIG. 3 is not illustrated. However, the channel allocating switch 8-2 has a similar configuration to the channel allocating switch 8-1.

The channel allocating switch 5 allocates channels to the television broadcast content servers 1-1, 1-2, . . . , 1-N, the default server 2 and the router 3 statically in advance, and also the channel allocating switch 5 allocates the above-mentioned channels to the broadcast VLANs 61-1, 61-2, . . . , 61-N, the default VLAN 62 and the Internet VLAN 63 statically in advance. Therefore, a static point-to-point connection is provided between one of the television broadcast content servers 1-1, 1-2, . . . , 1-N and a respective one of the content VLANs 61-1, 61-2, . . . , 61-N. Also, a static point-to-point connection is provided between the default server 2 and the default LAN 62. Further, a static point-to-point connection is provided between the router 3 and the Internet LAN 63.

Thus, the channel allocating switch 5 forwards broadcast contents or frames from the television broadcast content distributing servers 1-1, 1-2, . . . , 1-N, the default servers 2 and the router 3 to the LANs 61-1, 61-2, . . . , 61-N, 62 and 63, respectively.

On the other hand, the channel allocating switch 8-1 (8-2) allocates one or more of the channels to each of the television broadcast content receiving terminals 7-1 and 7-2 (7-3 and 7-4).

The connection between the channel allocating switches 8-1 (8-2) is carried out by a network layer, for example. On the other hand, the connection between the channel allocating switch 8-1 (8-2) and the television broadcast content receiving terminals 7-1 and 7-2 (7-3 and 7-4) is carried out by a data link layer, for example.

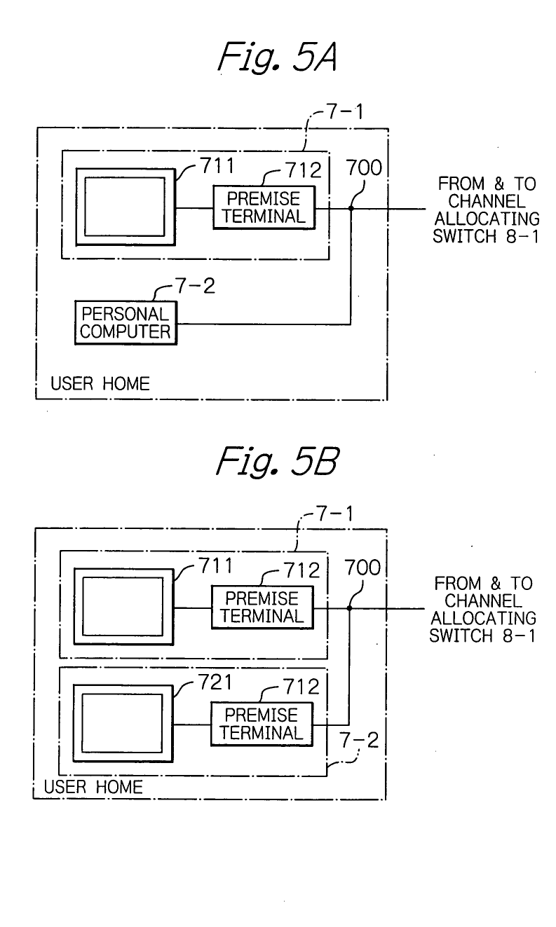

In FIG. 5A, which illustrates an example of the television broadcast content receiving terminals 7-1 and 7-2 of FIG. 4, the television broadcast content receiving terminals 7-1 and 7-2 are installed in one user home, and the television broadcast content receiving terminals 7-1 and 7-2 are connected to an additional point 700 which is connected to the channel allocating switch 8-1.

In FIG. 5A, the television broadcast content receiving terminal 7-1 is constructed by a television set 711 and a premise terminal 712, and the television broadcast content receiving 7-2 is constructed by a personal computer. As a result, the television set 711 can view a selected one of the broadcast contents of the VLANs 61-1, 61-2, . . . , 61-N and 62. Simultaneously, the personal computer 7-2 can be a member of the Internet VLAN 63 to view the Internet. Of course, if television software is installed into the personal computer 7-2, the personal computer 7-2 can view a selected one of the broadcast contents of the VLANs 61-1, 61-2, . . . , 61-N and 62.

In FIG. 5B, which illustrates another example of the television broadcast content receiving terminals 7-1 and 7-2 of FIG. 4, the television broadcast content receiving terminals 7-1 and 7-2 are also installed in one user home, and the television broadcast content receiving terminals 7-1 and 7-2 are connected to an additional point 700 which is connected to the channel allocating switch 8-1.

In FIG. 5B, the television broadcast content receiving terminal 7-1 is constructed by a television set 711 and a premise terminal 712, and the television broadcast content receiving 7-2 is constructed by a television set 721 and a premise terminal 722. As a result, the television set 711 can view a selected one of the broadcast contents of the VLANs 61-1, 61-2, . . . , 61-N and 62. Simultaneously, the television set 721 can view a selected one of the broadcast contents of the VLANs 61-1, 61-2, . . . , 61-N and 62.

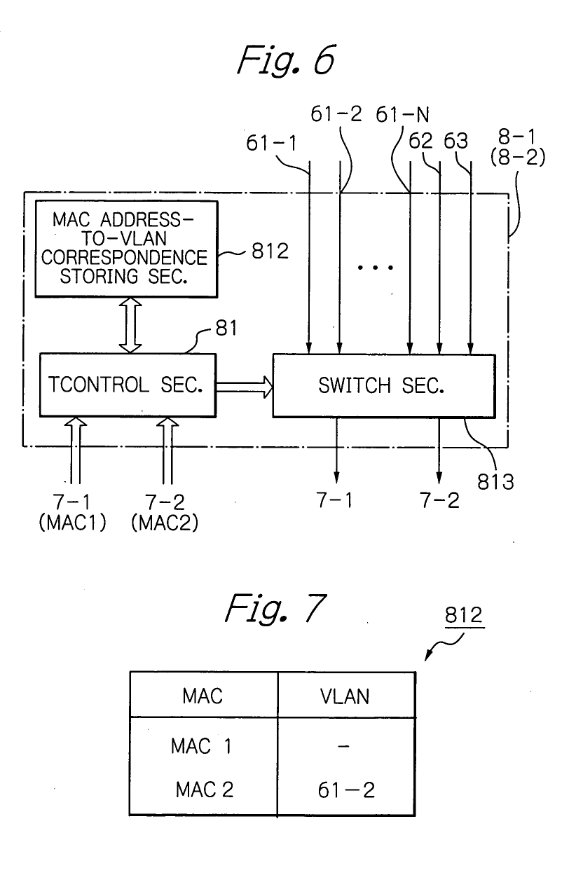

In FIG. 6, which is a detailed block circuit diagram of the channel allocating switch 8-1 (8-2) of FIG. 4, the channel allocating switch 8-1 (8-2) is constructed by a control section 811 which may include a central processing unit (CPU), a read-only memory (ROM) for storing programs and a random access memory (RAM) for storing temporary data, a media access control (MAC) address-to-VLAN correspondence storing section 812 which may include a nonvolatile memory, and a switch section 813 for allocating one of the VLANs 61-1, 61-2, . . . , 61-N, 62 and 63 to each of the television broadcast content receiving terminals 7-1 and 7-2.

An example of the MAC address-to-VLAN correspondence storing section 812 is illustrated in FIG. 7. In FIG. 7, the television broadcast content receiving terminals 7-1 and 7-2 have fixed MAC address MAC1 and MAC2, respectively. Note that a MAC address is a non-changeable physical address allocated to each equipment. Also, in FIG. 7, no channel (VLAN) is allocated to the television broadcast content receiving terminal 7-1, while the channel (VLAN 61-2) is allocated to the television broadcast content receiving terminal 7-2.

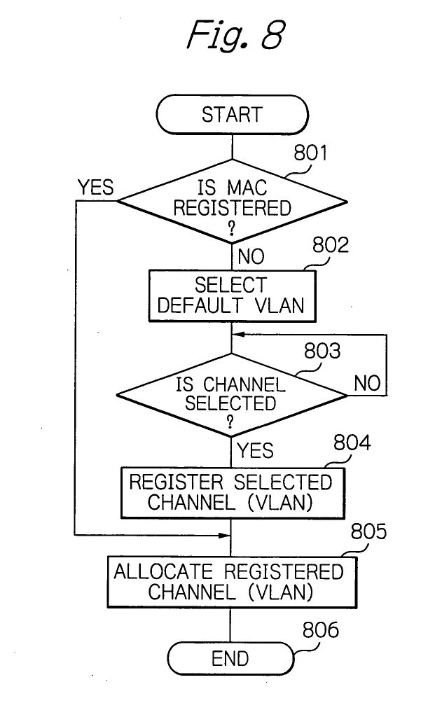

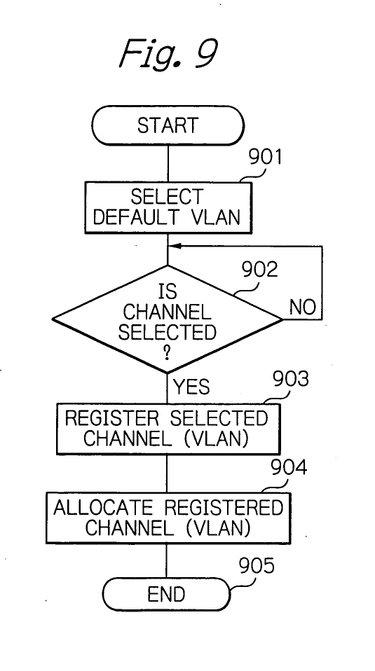

The operation of the control section 811 of FIG. 6 is explained next with reference to interrupt routines of FIGS. 8 and 9. Note that the routine of FIG. 8 is started by receiving a power on signal from one of the television broadcast content receiving terminals 7-1 and 7-2. On the other hand, the routine of FIG. 9 is started by receiving a switching request signal from one of the television broadcast content receiving terminals 7-1 and 7-2.

In FIG. 8, assume that the control section 811 has received a power-on signal from the television broadcast content receiving terminal 7-1.

First, at step 801, it is determined whether or not the MAC address MAC1 of the television broadcast content receiving terminal 7-1 is already registered in the MAC address-to-VLAN correspondence storing section 812. When the MAC address MAC1 is already registered, the control proceeds directly to step 805. On the other hand, when the MAC address MAC1 is not registered, the control proceeds to step 802.

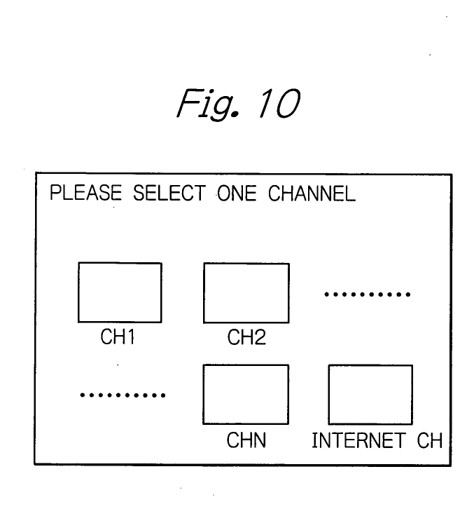

At step 802, the control section 811 causes the switch section 813 to select the default VLAN 62 for the television broadcast content receiving terminal 7-1. As a result, the default VLAN 62 is allocated to the television broadcast content receiving terminal 7-1, so that a menu of the television broadcast contents is distributed to the television broadcast content receiving terminal 7-1. Thus, a menu as illustrated in FIG. 10 is displayed in the television broadcast content receiving terminal 7-1. For example, in FIG. 10, reduced images of channels CH1, CH2, . . . , CHN of the VLANs 61-2, 61-2, . . . , 61-N and a predetermine image of the Internet channel of the VLAN 63 are displayed.

Next, at step 803, the control section 811 waits for the user to select one of the channels, i.e., the VLANs 61-1, 61-2, . . . , 61-N and the Internet VLAN 63. When one of the channels is selected by pushing a button switch, a keyboard or a pointing device such as a mouse, the control proceeds to step 804.

At step 804, the control section 811 registers the channel selected at step 803 in the MAC address-to-VLAN correspondence storing section 812.

Next, at step 805, the control section 811 causes the switch section 813 to allocate the registered channel (VLAN) to the television broadcast content receiving terminal 7-1.

Then, the routine of FIG. 8 is completed by step 806.

In FIG. 9, assume that the control section 811 has received a switching request signal from the television broadcast content receiving terminal 7-2.

First, at step 901, the control section 811 causes the switch section 813 to select the default VLAN 62 for the television broadcast content receiving terminal 7-2. As a result, the default VLAN 62 is allocated to the television broadcast content receiving terminal 7-2, so that a menu of the television broadcast contents as illustrated in FIG. 10 is distributed to the television broadcast content receiving terminal 7-2. Thus, the menu as illustrated in FIG. 10 is displayed in the television broadcast content receiving terminal 7-2.

Next, at step 902, the control section 811 waits for the user to select one of the channels, i.e., the VLANs 61-1, 61-2, . . . , 61-N and the Internet VLAN 63. When one of the channels is selected by pushing a button switch, a keyboard or a pointing device such as a mouse, the control proceeds to step 903.

At step 903, the control section 811 registers the channel selected at step 902 in the MAC address-to-VLAN correspondence storing section 812.

Next, at step 904, the control section 811 causes the switch section 813 to allocate the registered channel (VLAN) to the television broadcast content receiving terminal 7-2.

Then, the routine of FIG. 9 is completed by step 905.

Thus, the users of the television broadcast content receiving terminals 7-1 and 7-2 can view television broadcast contents in the same way as in the conventional terrestrial television sets.

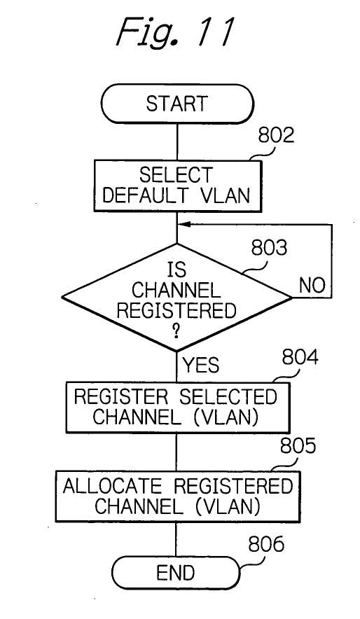

Note that, if the MAC address-to-VLAN correspondence storing section 812 of FIG. 6 is constructed by a volatile memory such as a dynamic RAM, the routine of FIG. 8 is modified to a routine of FIG. 11 where step 801 of FIG. 8 is deleted, since no MAC address is registered in the MAC address-to-VLAN correspondence storing section 812 of FIG. 6.

In FIG. 3, since a single fixed IP address (network address) defined by the router 3 is allocated to the distributing network 6, i.e., all the VLANs 61-1, 61-2, 61-N, 62 and 63, it is unnecessary to carrying out a dynamic allocation of IP addresses using a dynamic host configuration protocol (DHCP). Therefore, even when one VLAN is switched to another VLAN for the television broadcast content receiving terminal such as 7-1, a time period where no image is displayed does not occur in the television broadcast content receiving terminal 7-1.

Also, in FIG. 6, the MAC address-to-VLAN correspondence storing section 812 can be modified to store a history of the correspondence between the MAC addresses and the VLANs on a day and time basis. In this case, the control section 811 can initially allocated a likelihood of the LANs to the television broadcast content receiving terminal such as 7-1.

Further, in FIG. 10, the default server 2 cyclically receives the television broadcast contents from the television broadcast content distributing servers 1-1, 1-2, . . . , 1-N on a compressed-data basis, and time-expands the cyclically received television broadcast contents to generate reduced images corresponding thereto. However, the default server 2 can time-divisionally receive the television broadcast contents from the television broadcast content distributing servers 1-1, 1-2, . . . , 1-N and can time-divisionally generate images corresponding to the received television broadcast contents. In this case, since the signal processing is simplified, the images never deteriorate.

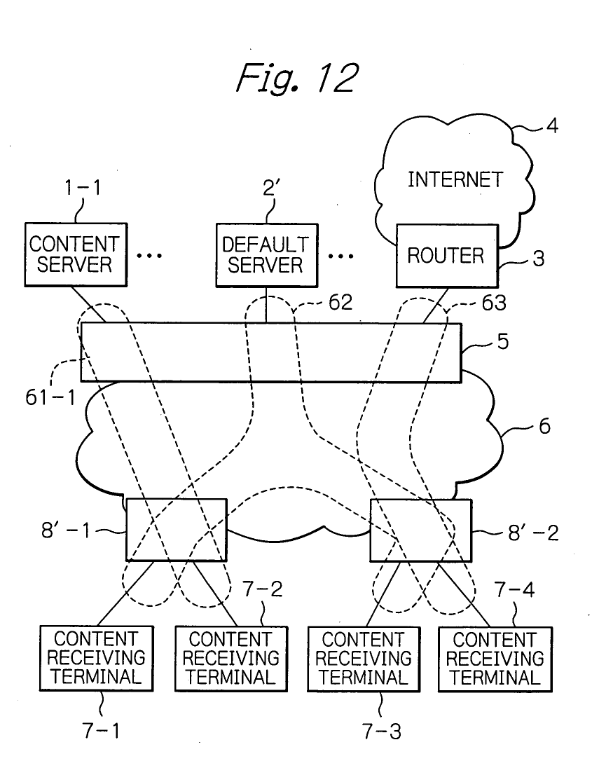

In FIG. 12, which illustrates a second embodiment of the television broadcast content distributing system according to the present invention, the default server 2 of FIG. 3 is replaced by a default server 2′ having a fee charging function. Also, the channel allocating switches 8-1 and 8-2 of FIG. 3 are replaced by channel allocating switches 8′-1 and 8′-2, respectively.

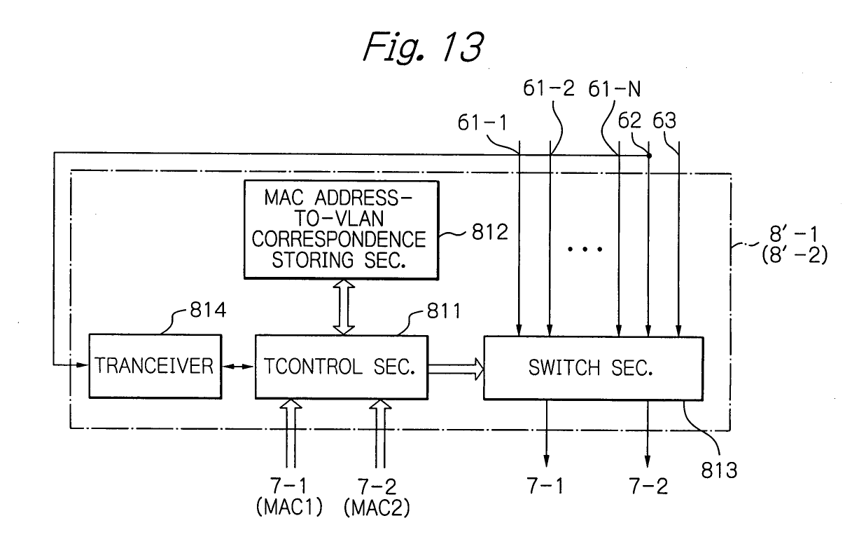

In FIG. 13, which is a detailed block circuit diagram of the channel allocating switch 8′-1 (8′-2) of FIG. 12, a transceiver 814 for communicating with the default server 2′ via the default VLAN 62 is added to the elements of the channel allocating switch 8-1 (8-2) of FIG. 6.

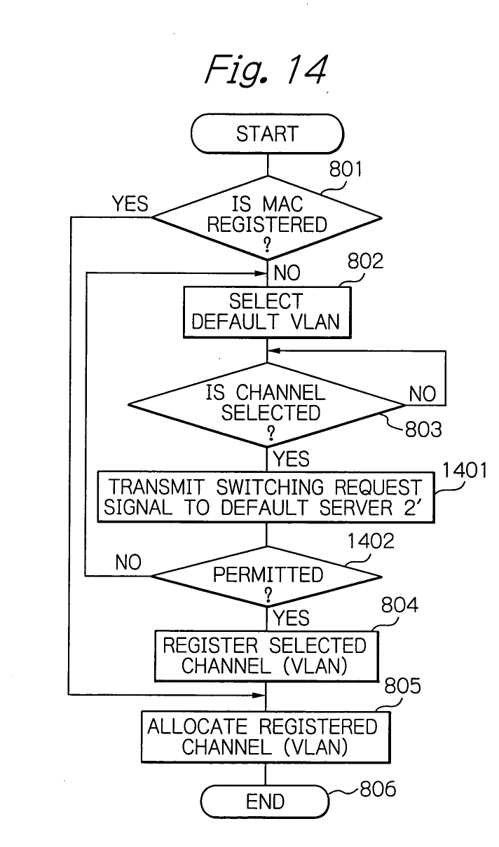

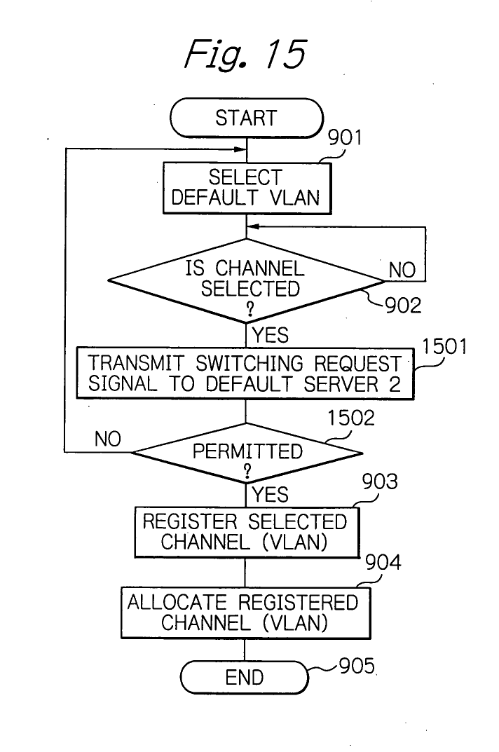

The operation of the control section 811 of FIG. 13 is explained next with reference to interrupt routines of FIGS. 14 and 15. Note that the routine of FIG. 14 is started by receiving a power-on signal from one of the television broadcast content receiving terminals 7-1 and 7-2. On the other hand, the routine of FIG. 15 is started by receiving a switching request signal from one of the television broadcast content receiving terminals 7-1 and 7-2. Also, in FIG. 14, steps 1401 and 1402 are added to the steps of FIG. 8, and, in FIG. 15, steps 1501 and 1502 are added to the steps of FIG. 9.

In FIG. 14, assume that the control section 811 has received a power-on signal from the television broadcast content receiving terminal 7-1.

First, at step 801, it is determined whether or not the MAC address MAC1 of the television broadcast content receiving terminal 7-1 is already registered in the MAC address-to-VLAN correspondence storing section 812. When the MAC address MAC1 is already registered, the control proceeds directly to step 805. On the other hand, when the MAC address MAC1 is not registered, the control proceeds to step 802.

At step 802, the control section 811 causes the switch section 813 to select the default VLAN 62 for the television broadcast content receiving terminal 7-1. As a result, the default VLAN 62 is allocated to the television broadcast content receiving terminal 7-1, so that a menu of the television broadcast contents is distributed to the television broadcast content receiving terminal 7-1. Thus, the menu as illustrated in FIG. 10 is displayed in the television broadcast content receiving terminal 7-1.

Next, at step 803, the control section 811 waits for the user to select one of the channels, i.e., the VLANs 61-1, 61-2, . . . , 61-N and the Internet VLAN 63. When one of the channels is selected by pushing a button switch, a keyboard or a pointing device such as a mouse, the control proceeds to step 1401.

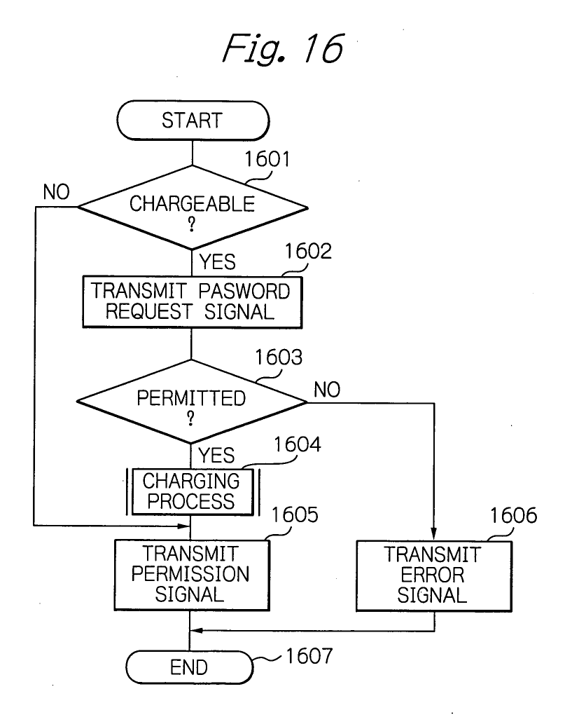

At step 1401, the control section 811 transmits a switching request signal via the default VLAN 62 to the default server 2′. As a result, the default server 2′ carries out an operation as illustrated in FIG. 16 which will be explained later, to thereby return a permission signal or an error signal to the control section 811.

Next, at step 1402, it is determined whether the control section 811 has received the permission signal or the error signal. Only when the control section 811 has received the permission signal, does the control proceed to step 804. Otherwise, the control returns to step 802.

At step 804, the control section 811 registers the channel selected at step 803 in the MAC address-to-VLAN correspondence storing section 812.

Next, at step 805, the control section 811 causes the switch section 813 to allocate the registered channel (VLAN) to the television broadcast content receiving terminal 7-1.

Then, the routine of FIG. 14 is completed by step 806.

Note that, if the MAC address-to-VLAN correspondence storing section 812 of FIG. 13 is constructed by a volatile memory such as a dynamic RAM, step 801 is deleted.

In FIG. 15, assume that the control section 811 has received a switching request signal from the television broadcast content receiving terminal 7-2.

First, at step 901, the control section 811 causes the switch section 813 to select the default VLAN 62 for the television broadcast content receiving terminal 7-2. As a result, the default VLAN 62 is allocated to the television broadcast content receiving terminal 7-2, so that a menu of the television broadcast contents as illustrated in FIG. 10 is distributed to the television broadcast content receiving terminal 7-2. Thus, the menu as illustrated in FIG. 10 is displayed in the television broadcast content receiving terminal 7-2.

Next, at step 902, the control section 811 waits for the user to select one of the channels, i.e., the VLANs 61-1, 61-2, . . . , 61-N and the Internet VLAN 63. When one of the channels is selected by pushing a button switch, a keyboard or a pointing device such as a mouse, the control proceeds to step 1501.

At step 1501, the control section 811 transmits a switching request signal via the default VLAN 62 to the default server 2′. As a result, the default server 2′ carries out an operation as illustrated in FIG. 16 which will be explained later, to thereby return a permission signal or an error signal to the control section 811.

Next, at step 1502, it is determined whether the control section 811 has received the permission signal or the error signal. Only when the control section 811 has received the permission signal, does the control proceed to step 903. Otherwise, the control returns to step 901.

At step 903, the control section 811 registers the channel selected at step 902 in the MAC address-to-VLAN correspondence storing section 812.

Next, at step 904, the control section 811 causes the switch section 813 to allocate the registered channel (VLAN) to the television broadcast content receiving terminal 7-2.

Then, the routine of FIG. 15 is completed by step 905.

The operation of the default server 2′ is explained next with reference to FIG. 16. Note that the routine of FIG. 16 is started by receiving a switching request signal from one of the channel allocating switches 8′-1 and 8′-2.

First, at step 1601, it is determined whether a channel (VLAN) requested by the switching request signal is chargeable or free. When the selected channel (VLAN) is free, the control proceeds directly to step 1605. On the other hand, when the selected channel (VLAN) is chargeable, the control proceeds to step 1602.

At step 1602, the default server 2′ transmits a password request signal to the control section of the channel allocating switch 8′-1 or 8′-2. Then, upon receipt of a password from the channel allocating switch 8′-2, the default server 2′ performs an authentication upon the received password in accordance with an authentication table (not shown) in the default server 2′. As a result, when the authentication result is permitted, the control proceeds to step 1604. On the other hand, when the authentication result, is erroneous, the control proceeds to step 1606.

At step 1604, the default server 2′ starts a fee charging process in accordance with a monitored chargeable time. Note that this fee charging process is carried out by a fee charging routine (not shown).

At step 1605, the default server 2′ transmits a permission signal to the channel allocating switch 8′-1 or 8′-2 via the default VLAN 62. On the other hand, at step 1606, the default server 2′ transmits an error signal to the channel allocating switch 8′-1 or 8′-2 via the default VLAN 62.

Then, the routine of FIG. 16 is completed by step 1607.

Thus, the users of the television broadest content receiving terminals 7-1 and 7-2 can view chargeable and free television broadcast contents in the same way as in the conventional terrestrial television sets.

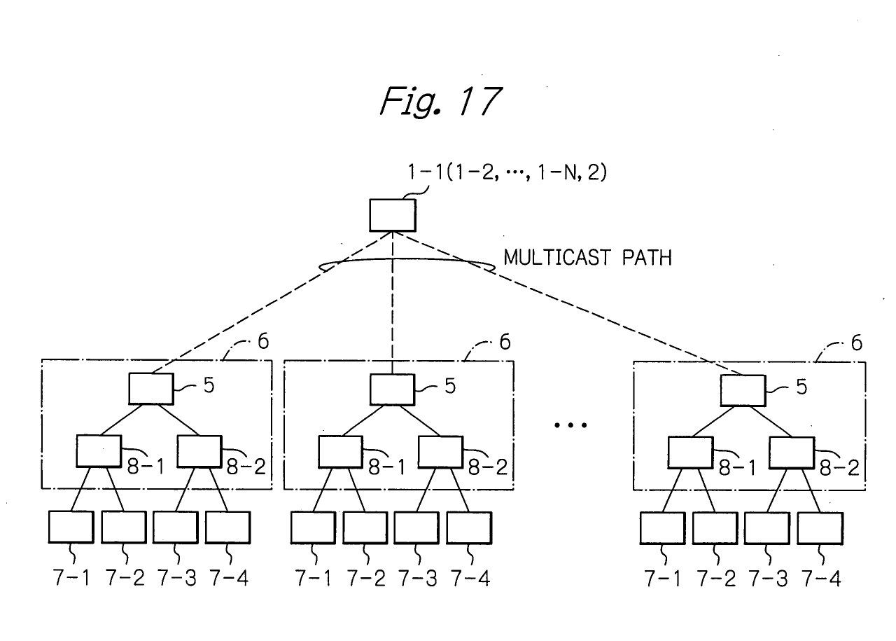

As illustrated in FIG. 17, a plurality of distributing networks 6 are actually provided around one country such as Japan, and each of the servers 1-1, 1-2, 1-N and 2 is provided commonly for the plurality of distributing networks 6 by using a multicast communication path. As a result, the number of servers can be decreased.

As explained hereinabove, since a television broadcast content distributing system according to the present invention does not need to be reconstructed even when each television broadcast content receiving terminal changes a selected channel, the television broadcast content distributing system is not cost and time consuming.

1. A television broadcast content distributing system comprising:
a plurality of television broadcast content distributing servers for generating television broadcast contents;
a plurality of television broadcast content receiving terminals for receiving said television broadcast contents;
a first channel allocating switch, connected to said television broadcast content distributing servers, for allocating channels to said television broadcast content distributing servers, respectively;
a plurality of second channel allocating switches, each connected to one or more of said television broadcast content receiving terminals, said each of said second allocating channel switches allocating one or more of said channels to said one or more of said television broadcast content receiving terminals; and
a plurality of virtual local area networks, each arranged in correspondence with one of said channels between outputs of said first channel allocating switch and inputs of said second channel allocating switches.

2. A television broadcast content distributing system comprising:
a plurality of television broadcast content distributing servers for generating television broadcast contents;
a default server for generating a menu of said television broadcast contents;
a plurality of television broadcast content receiving terminals for receiving said television broadcast contents and said menu of said television broadcast contents;
a first channel allocating switch, connected to said television broadcast content distributing servers and said default server, for allocating channels to said television broadcast content distributing servers and said default server, respectively;
a plurality of second channel allocating switches, each connected to one or more of said television broadcast content receiving terminals, said each of said second allocating channel switches allocating one or more of said channels to said one or more of said television broadcast content receiving terminals; and
a plurality of virtual local area networks, each arranged in correspondence with one of said channels between outputs of said first channel allocating switch and inputs of said second channel allocating switches.

3. The television broadcast content distributing system as set forth in claim 2, wherein each of said second channel allocating switches comprises:
a control section;
a correspondence storing section, connected to said control section, for storing a correspondence table between physical addresses of said television broadcast content receiving terminals connected to said each of said second channel allocating switches and selected ones of said virtual local area networks; and
a switch section, connected to said control section and provided between said virtual local area networks and one or more of said television broadcast content receiving terminals.

4. The television broadcast content distributing system as set forth in claim 3, wherein said correspondence storing section comprises a nonvolatile memory,
said control section receiving a power-on signal from one of said television broadcast content receiving terminals and allocating one of said virtual local area networks by referring to said correspondence storing section using a physical address of said one of said television broadcast content receiving terminals.

5. The television broadcast content distributing system as set forth in claim 3, wherein said correspondence storing section comprises a volatile memory,
said control section receiving a power-on signal from one of said television broadcast content receiving terminals and allocating one of said virtual local area networks by referring to said menu of said television broadcast contents generated from said default server.

6. The television broadcast content distributing system as set forth in claim 5, wherein said control section registers said allocated one of said virtual local area networks in said correspondence storing section by referring to the physical address of said one of said television broadcast content receiving terminals.

7. The television broadcast content distributing system as set forth in claim 3, wherein said control section receives a channel switching request signal from one of said television broadcast content receiving terminals and allocates one of said virtual local area networks by referring to said menu of said television broadcast contents generated from said default server.

8. The television broadcast content distributing system as set forth in claim 7, wherein said control section registers said allocated one of said virtual local area networks in said correspondence storing section by referring to the physical address of said one of said television broadcast content receiving terminals.

9. The television broadcast content distributing system as set forth in claim 2, wherein said default server cyclically receives said television broadcast contents from said television broadcast content distributing servers to generate said menu of said television broadcast contents by reducing images thereof.

10. The television broadcast content distributing system as set forth in claim 2, wherein said default server time-divisionally receives said television broadcast contents from said television broadcast content distributing servers to generate said menu of said television broadcast contents by time-divisionally generating said television broadcast contents.

11. The television broadcast content distributing system as set forth in claim 2, wherein each of said second channel allocating switches comprises:
a control section;
a correspondence storing section, connected to said control section, for storing a correspondence table between physical addresses of said television broadcast content receiving terminals connected to said each of said second channel allocating switches and selected ones of said virtual local area networks;
a switch section, connected to said control section and provided between said virtual local area networks and one or more of said television broadcast content receiving terminals; and
a transceiver, connected to said default server, for communicating with said default server.

12. The television broadcast content distributing system as set forth in claim 11, wherein said correspondence storing section comprises a nonvolatile memory,
said control section receiving a power-on signal from one of said television broadcast content receiving terminals and allocating one of said virtual local area networks by referring to said correspondence storing section using a physical address of said one of said television broadcast content receiving terminals.

13. The television broadcast content distributing system as set forth in claim 11, wherein said correspondence storing section comprises a volatile memory,
said control section receiving a power-on signal from one of said television broadcast content receiving terminals, reading one of said virtual local area networks by referring to said menu of said television broadcast contents generated from said default server, determining whether said read one of said virtual local area networks is chargeable or free, carrying out an authentication when said read one of said virtual local area networks is chargeable, and allocating said read one of said virtual local area networks when said read one of said virtual local area networks is free or when said authentication is permitted.

14. The television broadcast content distributing system as set forth in claim 13, wherein said control section registers said allocated one of said virtual local area networks in said correspondence storing section by referring to the physical address of said one of said television broadcast content receiving terminals.

15. The television broadcast content distributing system as set forth in claim 11, wherein said control section receives a channel switching request signal from one of said television broadcast content receiving terminals, reads one of said virtual local area networks by referring to said menu of said television broadcast contents generated from said default server, determines whether said read one of said virtual local area networks is chargeable or free, carries out an authentication when said read one of said virtual local area networks is chargeable, and allocates said read one of said virtual local area networks when said read one of said virtual local area networks is free or when said authentication is permitted.

16. The television broadcast content distributing system as set forth in claim 15, wherein said control section registers said allocated one of said virtual local area networks in said correspondence storing section by referring to the physical address of said one of said television broadcast content receiving terminals.

17. The television broadcast content distributing system as set forth in claim 2, further comprising:
an Internet protocol router connected to said first channel allocating switch; and
an additional virtual local area network arranged in correspondence with a channel for said Internet protocol router between an output of said first channel allocating switch and the outputs of said second channel allocating switches.

18. The television broadcast content distributing system as set forth in claim 17, wherein a fixed Internet protocol address is given to said system.

19. A television broadcast content distributing system comprising:
a plurality of television broadcast content distributing servers for generating television broadcast contents;
a plurality of television broadcast content receiving terminals for receiving said television broadcast contents;
a plurality of first channel allocating switches, connected to said television broadcast content distributing servers using multicast communication paths, for allocating channels to said television broadcast content distributing servers, respectively;
a plurality of groups of second channel allocating switches, each connected to one or more of said television broadcast content receiving terminals, said each of said second allocating channel switches allocating one or more of said channels to said one or more of said television broadcast content receiving terminals; and
a plurality of groups of virtual local area networks, each group arranged in correspondence with one of said channels between outputs of one of said first channel allocating switches and inputs of one group of said second channel allocating switches.

20. A television broadcast content distributing system comprising:
a plurality of television broadcast content distributing servers for generating television broadcast contents;
a default server for generating a menu of said television broadcast contents;
a plurality of television broadcast content receiving terminals for receiving said television broadcast contents and said menu of said television broadcast contents;
a plurality of first channel allocating switches, connected to said television broadcast content distributing servers and said default server using multicast communication paths, for allocating channels to said television broadcast content distributing servers and said default server, respectively;
a plurality of groups of second channel allocating switches, each connected to one or more of said television broadcast content receiving terminals, said each of said second allocating channel switches allocating one or more of said channels to said one or more of said television broadcast content receiving terminals; and
a plurality of groups of virtual local area networks, each group arranged in correspondence with one of said channels between outputs of one of said first channel allocating switches and inputs of one groups of said second channel allocating switches.

21. A television broadcast content distributing system comprising:
a plurality of television broadcast content distributing servers for generating television broadcast contents;
a default server for generating a menu of said television broadcast contents;
an Internet protocol router;
a plurality of television broadcast content receiving terminals for receiving said television broadcast contents and said menu of said television broadcast contents and communicating with the Internet;
a plurality of first channel allocating switches, connected to said television broadcast content distributing servers, said default server and said Internet protocol router using multicast communication paths, for allocating channels to said television broadcast content distributing servers, said default server and said Internet protocol router, respectively;
a plurality of groups of second channel allocating switches, each connected to one or more of said television broadcast content receiving terminals, said each of said second allocating channel switches allocating one or more of said channels to said one or more of said television broadcast content receiving terminals; and
a plurality of groups of virtual local area networks, each groups arranged in correspondence with one of said channels between outputs of one of said first channel allocating switches and inputs of one group of said second channel allocating switches.
